(19) United States
(12) Patent Application Publication
(10) Pub. No.: US 2003/0188628 A1
(43) Pub. Date: Oct. 9, 2003

(54) Hardware and software and software interface for control by midi messages

(76) Inventors: Naguy Caillavet, Toulouse (FR); Gilles Moncaubeig, Saint Pierre les Elbeufs (FR)

Correspondence Address: YOUNG & THOMPSON, 745 SOUTH 23RD STREET 2ND FLOOR, ARLINGTON, VA, 22202

(21) Appl. No.: 10/221,652

(22) PCT Filed: Mar. 15, 2001
(86) PCT No.: PCT/FR01/00762

(51) Int. Cl. G10H 7/00

(52) U.S. Cl. 84/645

(57) ABSTRACT

The invention, operating on the MIDI (Musical Instrument Digital Interface) standard, aims at providing a personal computer user (12) an external peripheral (8) in the form of a table of switching and potentiometric controllers and its managing software (9), the whole set providing real time control of parameters used by controllable client software's (1) or external hardware systems (14) capable of operating the MIDI standard. The invention should be considered as a complementary extension of conventional man-machine interfaces which consist in the keyboard and mouse to the extent that it enables to control parameters from rotary potentiometers, linear potentiometers and switches. The invention comprises two parts, hardware and software. The hardware (8) is a console of controllers whereof the electronic production is very simple, hence inexpensive. The software (9), resident in storage after launching, scans the values of the console of controllers via a connection port (13) of the computer. Said values, whether after being transformed or not, are provided to the client software's in real time by sending messages observing the MIDI standard to a software (10) or hardware (11) MIDI peripheral. The client applications (1) of the invention can be software's of different fields of application (computer-assisted music, computer graphics, and the like) or software's controlling external hardware systems (14) if they authorise it. The invention converts the values derived from the console in the form of MIDI messages. Thus, the software's compatible with said standard can be controlled by the table. Furthermore, the MIDI data can be directly routed to a hardware MIDI peripheral (11) (of the board for instance) to control likewise hardware MIDI machines (15) such as synthesizer, beatbox, sound effects and the like.

The technical performances of personal computers are constantly advancing, leading to ever greater interactivity between applications or software items and the user. For example, a musical application which previously required twenty seconds of calculation to generate one second's sound from a wave form and any parameters (attack, filter, gain, panoramic, etc.), only requires a hundredth of a second today to carry out the same task. This reduction in the calculating times permits applications to offer more interactivity with the user and to propose control of their internal parameters in real time.

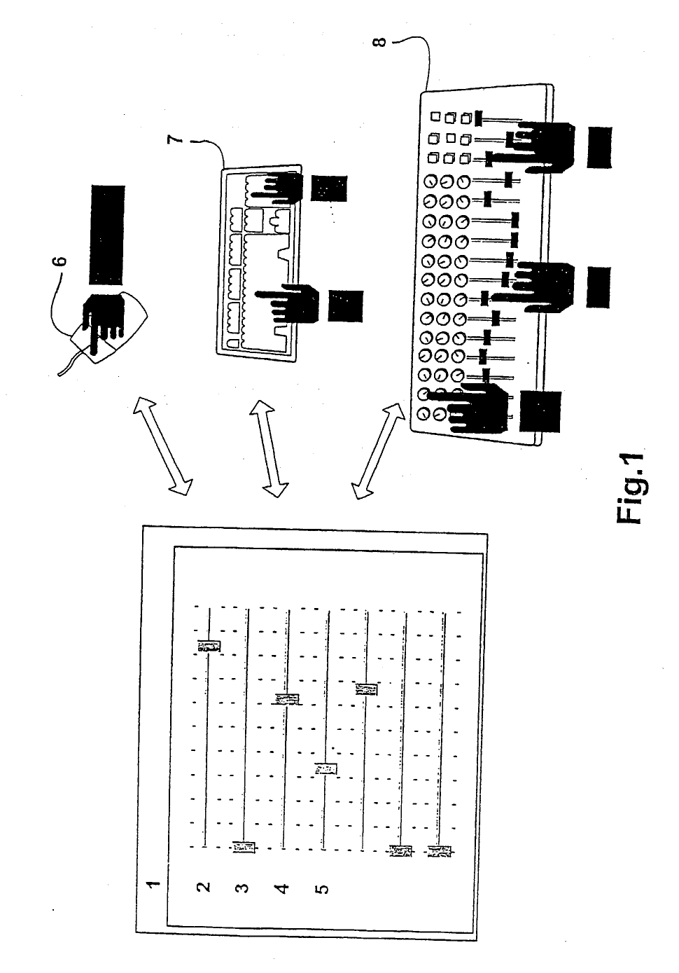

The problem is the lack of efficient manual controllers which permit the user to control these parameters in real time. In the majority of cases, the user must programme the values of the parameters in time (hence a loss of interactivity), or modify these parameters with the mouse or with the keyboard, which are two man-machine interfaces not suited to this use, as FIG. 1 shows.

The present invention intends to overcome these disadvantages. More precisely, it comprises an apparatus for manually controlling parameters of software applications in real time, characterised in that it comprises a hardware part, made up of potentiometers (linear or rotary) and/or of switches, and a configurable software part, which generates messages consistent with the MIDI (Musical Instrument Digital Interface) standard, these two parts being connected through a connection port of a personal computer.

According to one advantageous feature, the apparatus according to the invention uses an (output) hardware MIDI peripheral, of the sound card type, of the personal computer to control the hardware MIDI machines.

According to another feature, the connection port is the parallel port of the personal computer.

According to another feature, the connection port is a USB port of the personal computer.

The invention also relates to a method, based on the apparatus according to the invention, of controlling parameters of software applications capable of operating the MIDI standard, characterised in that it comprises stages of configuring/allocating, acquiring data, transforming data and generating messages operating the MIDI standard.

The invention also relates to a method, based on the apparatus according to the invention, of controlling parameters of hardware machines capable of operating the MIDI standard, characterised in that it comprises stages of configuring/allocating, acquiring data, transforming data and generating messages operating the MIDI standard.

According to a feature of the method according to the invention, so-called virtual controllers are created, the values of which depend either on programmed values or on the values of another controller (physical or virtual), to which values transforming functions (predefined or personalised) are applied.

According to a feature of the method according to the invention, so-called relay controllers are created, which permit transforming functions (predefined or personalised) to be applied to values of remote controllers, which values are transmitted by means of an intranet or internet network.

According to another feature, any hardware external systems are controlled by means of client applications, which are capable of controlling these systems and of operating the MIDI standard.

Other advantages will appear, on reading hereinafter of embodiments of the invention, together with the accompanying drawings, the embodiments being given by way of non-limiting illustrations.

FIG. 1 compares the invention with the mouse and with the keyboard as man-machine interfaces.

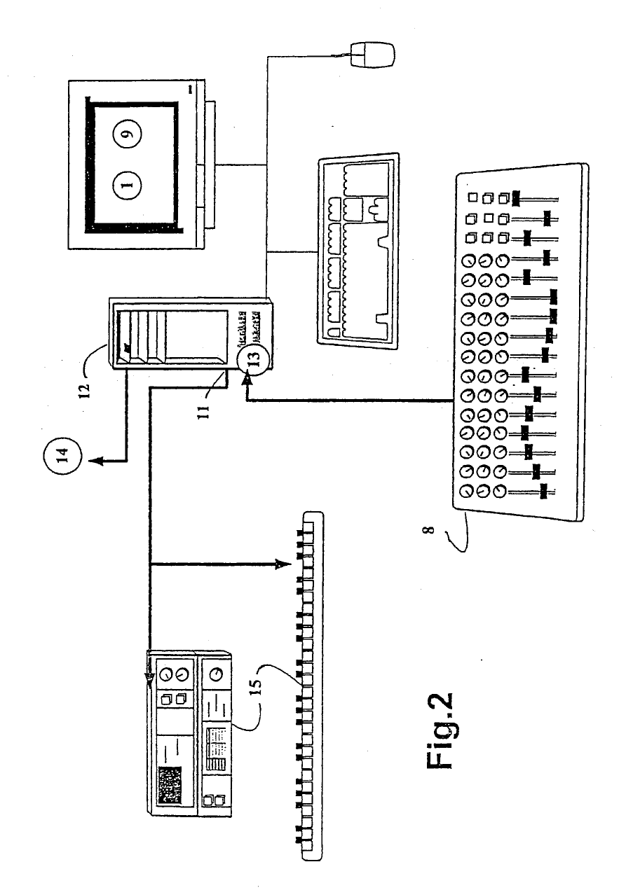

FIG. 2 gives a general view of the use of the invention.

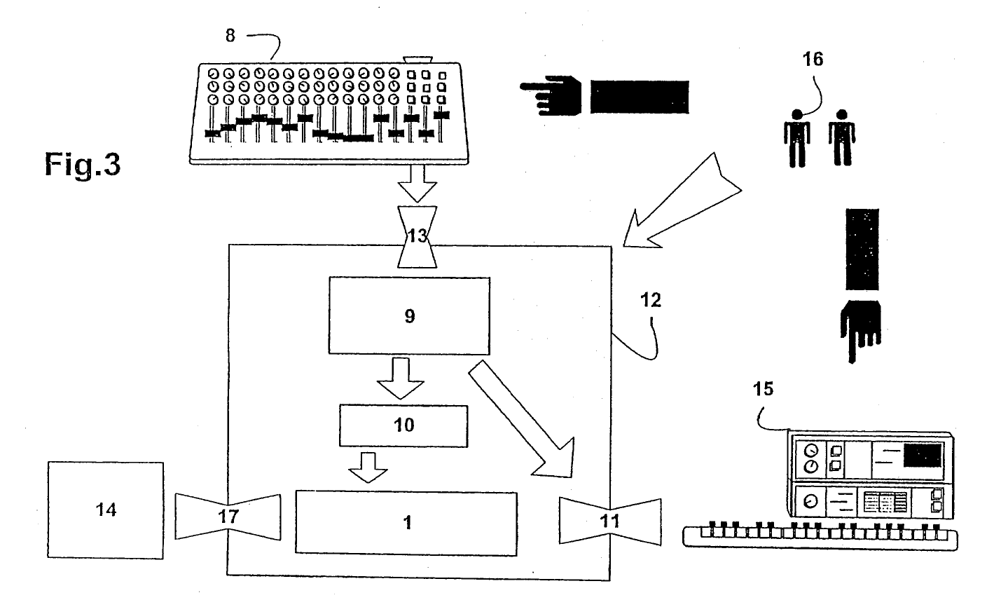

FIG. 3 breaks down FIG. 2 at the level of the personal computer.

FIG. 1 is based on the example of a client application illustrated by the outline 1, which permits n parameters to be controlled by any method, each parameter having a different role and a specific range of values: parameter 2 the intensity (0 to 127) of the lighting in the kitchen, parameter 3 the state (on/off) of an alarm, parameter 4 the volume (0 to 30) of the television, parameter 5 the panoramic (−32 to +32) of the PC sound, etc.

In the first case, the user has the mouse 6 to control the n parameters. He can click on the cursor of a parameter and, by displacing the mouse, modify the value of this parameter. The fault with this interface comes from the fact that the user does not have access to more than one parameter at the same time. By analogy, it could be said that he can only make use of a single one of his ten fingers.

In the second case, the keyboard 7 is managed by the application and permits parameters to be modified via certain keys of said keyboard, which are configurable or not. If the management of the keyboard is advanced, it permits a plurality of parameters to be controlled at the same time: I increase the light in the kitchen by pressing on the Q key and I reduce the sound of the television (key-embedded). However, it must be noted that there is a compromise between speed and accuracy with modifications by the keyboard; it is difficult to set parameters to sufficiently accurate values very rapidly (unless they are memorised). On the other hand, the mouse in the preceding case permits this (rapid displacements after the selection click).

This problem of the lack of efficient controllers to drive software parameters is also experienced by users of hardware MIDI machines (synthesisers, effects and other instruments of electronic music) which already have, in the case of some machines, controllers in real time of the potentiometer or switch type. However, these can rapidly become insufficient in number.

One solution is available on the market for users of hardware MIDI machines who wish to increase the real time interactivity of these machines: tables of ‘hardware MIDI’ controllers, which operate the MIDI standard and are integrated directly (without a computer) in a sequence of other hardware MIDI apparatuses since they have physical MIDI-IN and MIDI-OUT ports. However, their production cost is quite high (a complex electronic application) and, in general, they only offer few controllers.

The present invention, by operating the MIDI (Musical Instrument Digital Interface) standard set up by the MIDI international association, proposes placing, at the disposition of the user of a personal computer, an external peripheral, in the form of a table of controllers (potentiometers and switches) and its management software, all of which permits the control, in real time, of parameters used by client software items or controllable external hardware systems capable of operating the MIDI standard.

The present invention must be considered as a complementary extension of conventional man-machine interfaces which are the keyboard and the mouse, insofar as it permits parameters to be controlled from rotary potentiometers, linear potentiometers and switches.

Contrary to the keyboard 6, which sends occurences of the Boolean type (embedded or non-embedded key), and to the mouse 7, which is analogous to a single control “finger”, the desk 8 of the invention offers simultaneous control of the parameters and makes available values coded on m bits (0 to 2^{m}). Thus, one or more users can control with their ten fingers the parameters of their choice, and adjust predetermined values rapidly and more accurately by means of linear potentiometers, rotary potentiometers and switches.

FIG. 2 gives a general view of the use of the invention.

The present invention comprises two parts, a piece of hardware and a piece of software. The hardware part 8 is a desk of controllers, the electronic production of which is very simple and inexpensive for reasons explained hereinafter. The software 9, which remains in the memory after starting, scrutinises the values of the controllers of the desk via a connection port of the computer. These values, after being transformed or not, are made available to client software items in real time by the sending of messages conforming to the MIDI standard to a software MIDI peripheral 10 or a hardware MIDI peripheral 11.

The software part 9 of the invention is installed on a personal computer 12, where the client applications 1 of the invention, which are capable of operating the MIDI standard, are started.

Via a connection port 13, the software part of the invention reads the values of the various controllers which the hardware part, the desk 8, has. These controllers are of the linear potentiometer type, the rotary potentiometer type and the switch type.

The client applications 1 of the invention may be software from various fields of application (computer-aided music, infography, etc.) or software items for controlling external hardware systems 14, if they permit it.

The invention puts the values coming from the desk into the form of MIDI messages. Thus, software items compatible with this standard will be able to be driven by the table. Moreover, MIDI information can be routed directly to a hardware MIDI peripheral 11 (a sound card, for example) to control hardware MIDI machines 15 also, of the synthesiser, rhythm box, sampler, effects type, etc.

FIG. 3 itemises FIG. 2 at the level of the computer 12. The user or users 16 of this computer manipulate the external peripheral or desk of controllers 8 which, with the software of the invention 9, make up the innovation. These two parts, the hardware part 8 and the software part 9, communicate through the input of a connection port 13 of the personal computer (parallel port, USB interface, etc.). The values of the rotary potentiometers, linear potentiometers and switches, read at a given instant t, are routed to a hardware MIDI peripheral 10 and, by this means, are made available to the client software items 1, which are capable of operating the MIDI standard and in which any parameters are allocated to one or more controllers of the desk.

Thus, the client software items used have values coming from the desk by means of the software part of the invention which serves, as a consequence, as an interface.

It must be noted that only the variations in the values of the controllers cause MIDI messages to be generated, in order not to overload communication. Thus, the invention creates links or allocations between the controllers of the desk and the parameters of the client software items or of the hardware systems, and it does this in real time.

For example, for musical use, great interactivity is then available between the user or users and their musical creations during works of composition. These are produced by means of the musical client software items (sequencers, samplers, digital effects, etc.). This interactivity exists similarly when pieces of music are being played in real time. Thus, it is possible to allocate controllers to effects parameters on the instruments, such as volume, frequency, panoramic, echo, wave form, etc. The invention therefore becomes a control extension for these virtual instruments.

The values of the rotary potentiometers, linear potentiometers and switches, read at a given instant t, can also be routed directly to a hardware MIDI peripheral 11 (a sound card peripheral, for example), and by this means made available to hardware MIDI machines 15, in which any parameters are allocated to one or more controllers of the desk. Thus, the hardware MIDI machines in a studio can be controlled, at the same time, by the client software items and by the control desk 8. The personal computer, equipped with the invention, is then integrated in the MIDI sequence made up of the various elements in the studio. The invention offers a substantial complement of controllers in addition to those already present, but very often in small number, on these hardware MIDI machines. By using the invention, allocations are facilitated by the possibility of displaying the allocation parameters of a great number of controllers of the desk, and of modifying them, rapidly and simultaneously. Moreover, the invention provides the possibility of saving the allocations defined by the user in files. This avoids the user having to redefine his allocations before each composition or interpretation, and also permits allocation type files corresponding to hardware MIDI machines on the market to be proposed.

In addition to the musical use of the apparatus, if external systems 14, connected to the personal computer through a port 17, are controllable by the client software 1, and if this software permits their parameters to be allocated by the MIDI standard, then these parameters can be controlled by the control desk 8. As explained hereinafter, the invention improves the quality of the messages by possible use of MIDI SYSEX (SYStem EXclusif) messages. These permit ranges of values greater than that of a conventional MIDI controller (0 to 127) to be operated. The generation of SYSEX messages particular to manufacturers of hardware MIDI machines forms part of the invention, and permits the user to send specific commands to an item of hardware.

Description of the hardware part of the innovation:

Through its conception, this external peripheral has the advantage of offering flexibility in the definition of its configuration and of its design. Thus, it is possible to produce models in the form of an inclined table or in the form of a rack. The difference comes from the fact that, in the rack format, the potentiometers and switches are manipulatable on a vertical facade. But the invention does not stop at being able to select a controller from a rotary potentiometer and a linear potentiometer, it permits a potentiometer to be replaced by a plurality of switches without casting doubt on the design of the electronic processing circuit.

The control logic of the electronic processing circuit is simple, and allows modular desks to be produced (which it is possible to connect up in sequence). This permits desks to be produced at various costs, depending on the number of controllers that they have. It is also possible to imagine that the user can determine the design of his desk himself and thus place an order.

The electronic processing circuit is simple to produce and inexpensive. It relies substantially on the use of analogical/digital series converters, the control of which is completely assured, in its parallel port version, by the software part which even generates the various clock signals. The selected converters form part of a complete family of analogical/digital series converters, the number of inputs of which varies, existing in 8 bits and 12 bits, their control logic remaining the same. The technique used is that of putting, on each input of the various converters (up to 8 converters possible in the case where the connection port used is the parallel port), the output of a voltage divider for a controller of the potentiometer type or the output of an R/2R assembly with an adding means for x controllers of the switch type. This technique permits potentiometers to be used without worrying about their particular ohmic resistance, it also permits a potentiometer on the desk to be replaced very simply by x switches, up to a maximum number equal to the number of bits of the converter used.

The use of these series converters permits advantage to be taken of a large number of analogical inputs, but it provides constraints in respect of reading one of these inputs. The method selected is to read, continuously and in parallel on the x converters present on the desk model, the inputs of the first to the last, one after the other, according to the data conversion/acquisition time. This permits 8 values to be retrieved at once on the desk model connected through the parallel port (use of all of the data bus) and equipped with 8 converters, but those inputs read will only be able to be read again after a certain number of readings of the other inputs, depending on their number. For example, if the desk is equipped with 8 analogical/digital series converters of 12 bits, each having 11 analogical inputs, the reading of the 0 inputs of each converter will be carried out every 11 periods of data conversion/acquisition.

The connection between the computer and the desk depends on the type of connection port used by the version of the desk, and is made with standard cables available in the market place (parallel cable, USB cable, etc.).

The hardware peripheral needs only very little current, and is supplied at a continuous voltage of between 12 Volts and 15 Volts, regulated to 5 Volts. The use of a supply of 300 mA or 500 mA, available on the market, is sufficient for its operation. The choice of a supply external to the main or internal casing (rack version, for example) is to be considered.

It is important to stress the simplicity of the electronics used: the production cost of the table depends substantially on the price invested in the controllers which are the rotary and linear potentiometers (touch, sturdiness, precision). It is there that the innovation is interesting, since there are no electronics responsible for directly generating messages conforming to the MIDI standard. It is the software of the invention which is responsible for reading and translating the digital values of the peripheral. This greatly reduces the price in design terms, in maintenance terms and in development terms relative to tables of exclusively hardware MIDI controllers. The MIDI standard is recognised throughout the world, and is favoured by many musical applications. Moreover, non-musical client applications (PAO, infography, control of automata, etc.) already operate or will easily be able to operate the MIDI standard.

Mode of operation of the software:

After being started by the user, the software itself recognises the type of desk(s) connected to the computer, and then suggests a list of different models to the user. The recognition of the type of desk(s) is effected by reading at the connection port in order to determine the number of digital analogical converters present and the number of inputs which they have (physical controllers).

After this stage of recognising the hardware, the software presents the user with a main screen provided with a menu, a line of icons representing the most usual functions accessible through the menu, boxes to tick and buttons.

The following function, which is without any doubt the main one in using the invention, relates to the configuration of the controllers.

The physical controllers of the desk are among these, but the software part of the invention allows new controllers to be created, called virtual controllers and relay controllers. The configuration of the controllers is the total of the information associated with each one of the controllers. The user may use predefined configurations, and may modify, load and save these. In a configuration, the user selects the physical controllers which he wishes to use. For each controller, the user allocates a MIDI controller number (0 to 127), a MIDI channel number (0 to 15) and a MIDI output peripheral (hardware or software). The user also specifies whether he wishes to restrict the range of values from 0 to 127, to be compatible with the MIDI standard, or whether he wants a more extensive range of values. In this case, the message sent will be a MIDI SYSEX (SYStem EXclusif) message, with an appropriate manufacturer identification and a raft of specific data which will have to be able to be interpreted by the destination client of the message. The range of values will be a function of the type of converter selected and of the transformation function applied for each controller. Finally, the user can generate MIDI SYSEX messages appropriate to other MIDI peripheral manufacturers, and this will permit them to associate, for example, one switch of the desk with a very specific command for an apparatus. He then defines all of the raft of values sent in the message, of which the value of the controller may form a part.

The user also has the possibility of calibrating a physical controller, of selecting a range of values (minimum and maximum values) and of applying a transformation function (existing or appropriate to the user). For example, the transformation functions may be functions of the logarithmic or inverse logarithmic type which permit a linear physical controller to be transformed into a logarithmic virtual controller or the opposite.

Virtual controllers have the characteristic of being able to be dependent on one source of values. The source may be a physical controller or another virtual controller. Thus, at an instant t, a virtual controller may take on the value of a physical controller to which a transformation function is applied. Moreover, the source of a virtual controller may be a program of values which permit it to assume a certain value as a function of time. It is thus possible, at one precise moment (for example, set on an alarm), to start programs on virtual controllers which will carry out the actions, for example, of opening the blinds (household software driving an extension card to which is connected a stepping motor) and of progressively reducing the volume of a piece of music being read (MAO software).

The software part of the invention permits a network of the intranet or internet type to be used to exchange information on the controllers of a desk. In this case, the software part of the invention must be started either in server mode or in client mode of a server. In server mode, the software part of the invention is configured to send MIDI messages to one or more clients via the network, by using either the TCP/IP protocol or the UDP protocol (which offers better delivery but with possible losses of messages). The software parts of the invention placed in client mode are, for their part, configured to receive information coming from the network by associating it with relay controllers. These relay controllers are created and configured in a manner equivalent to that of the physical or virtual controllers, yet with the need to indicate the source of the values to be taken into account for each of them. This source is a remote virtual or physical controller configured at the level of the software part of the server. Indicating the source amounts to giving the identity of this physical or virtual controller of the server (MIDI controller no., MIDI channel no.).

The different fields of operation of the combined software and hardware of the invention are varied.

Firstly, for its possibilities of controlling hardware MIDI machines in a studio, it is intended for musicians using a computer, and this is often the case since music is more and more computer-aided.

Next, for its possibilities in controlling software client applications, the invention is intended to appeal to users of audiovisual computing in general. For musical software (real time sound synthesis, composition of sequences, samplers, etc.), the simultaneous control of numerous parameters, grouped together on one and the same desk, can increase the interactivity, and therefore the productivity. For software for reading compressed samples (for example, MP3 format), the user of the invention can allocate various tracks to the controllers, and a frequency equaliser for each one of them, for example, and can thereby mix these pieces of music as he would do with a conventional audio mixing table (Disc Jockey). In the visual field, the invention can control parameters of infography, of 3D synthesis, of video or cinematographic editing, of computer-aided publishing, etc. Similarly, modifications, in real time, of lighting parameters connected to the music are used more and more by Visual Jockeys, who can achieve, with the invention, ease of control, in real time, of the parameters which they wish to cause to vary.

Finally, if the client applications of the invention permit hardware systems external to the computer (household, automata, robots, etc.) to be controlled and these applications operate the MIDI standard, the invention permits the simultaneous control of numerous parameters of different natures, grouped together on one and the same desk. In fact, the control of any household electronic apparatus or such tends to be integrated with the computer, and the MIDI standard may be selected to control them.

1. Apparatus for manually controlling parameters of software applications (1) in real time, characterised in that it comprises a hardware part (8), made up of potentiometers (linear or rotary) and/or of switches, and a configurable software part (9), which generates messages consistent with the MIDI (Musical Instrument Digital Interface) standard, these two parts being connected through a connection port (13) of a personal computer (12).

2. Apparatus according to claim 1, characterised in that it uses an (output) hardware MIDI peripheral (11), of the sound card type, of the personal computer to control the hardware MIDI machines (15).

3. Apparatus according to claim 1, characterised in that the connection port (13) is the parallel port of the personal computer (12).

4. Apparatus according to claim 1, characterised in that the connection port (13) is a USB port of the personal computer (12).

5. Method, based on the apparatus according to claims 1 or 3 or 4, of controlling parameters of software applications capable of operating the MIDI standard, characterised in that it comprises stages for configuring/allocating, acquiring data, transforming data and generating messages operating the MIDI standard.

6. Method, based on the apparatus according to claims 2 or 3 or 4, of controlling parameters of hardware machines capable of operating the MIDI standard, characterised in that it comprises stages of configuring/allocating, acquiring data, transforming data and generating messages operating the MIDI standard.

7. Method according to claim 5 or 6, characterised in that so-called virtual controllers are created, the values of which depend either on programmed values or on the values of another controller (physical or virtual), to which values transforming functions (predefined or personalised) are applied.

8. Method according to any of claims 5 to 7, characterised in that so-called relay controllers are created, which permit transforming functions (predefined or personalised) to be applied to values of remote controllers, which values are transmitted by means of an intranet or internet network.

9. Method according to claim 5 or 8, characterised in that any hardware external systems (14) are controlled by means of client applications (1), which are capable of controlling these systems and of operating the MIDI standard.
